(19) United States
(12) Patent Application Publication
(10) Pub. No.: US 2009/0256347 A1
(43) Pub. Date: Oct. 15, 2009

(54) SILICONE OIL-REPELLENT PAPER PRODUCT COATED WITH A THERMOPLASTIC ADHESIVE

(75) Inventor: Reinhold Uhlemayr, Rutesheim (DE)

Correspondence Address: Fleit Gibbons Gutman Bongini & Bianco PL, 21355 EAST DIXIE HIGHWAY, SUITE 115, MIAMI, FL, 33180, US

(73) Assignee: BAYROPA JUNG GMBH, Wertingen (DE)

(21) Appl. No.: 12/421,912

(22) Filed: Apr. 10, 2009

(30) Foreign Application Priority Data
Apr. 11, 2008 (DE) 10 2008 019 211.2

(51) Int. Cl. B42D 15/10; B41M 5/50; B32B 7/12; C09J 5/06; B42D 15/00

(52) U.S. Cl. 283/72; 428/346; 428/350; 428/211.1; 428/342; 283/106

(57) ABSTRACT

The present invention makes available a paper product with a silicone oil-repellent, activatable adhesive coating that can be printed with a laser printer, with the adhesive coating serving to seal a single sheet to itself or neighboring sheets of paper products to one another, and with the silicone-oil repellency being obtained by means of a material selected from the group of fluoroalkyl sodium sulfate(s), fluoroalkyl polyoxyethylene polymer(s), polyvinyl alcohol(s) and mixtures thereof.

### CROSS-REFERENCE TO RELATED APPLICATION

This application claims priority under 35 U.S.C. §119 to German Patent Application No. 10 2008 019 211.2 filed Apr. 11, 2008, the entire contents of which are incorporated herein by reference.

### FIELD OF THE INVENTION

The present invention relates to a paper product with a silicone oil-repellent, activatable adhesive coating that can be printed with a laser printer, with the adhesive coating serving to pressure-seal a single sheet or neighboring sheets of paper products to one another, and with the silicone-oil repellency being fine-tuned by means of a silicone oil-repellent material. The adhesive contains a silicone oil-repellent material, preferably a silicone oil-repellent surfactant. Silicone oil-repellent surfactants to be used include, for example, fluorochemical surfactants. It can also be useful to use polyvinyl alcohol(s) instead of, or in combination with, these surfactants.

More specifically, the present invention relates especially to paper products comprising a single sheet with a silicone oil-repellent, activatable adhesive coating that can be printed with high-performance laser printers and which, after printing, can subsequently be folded and sealed without intermediate temporary storage to form a finished pressure-seal mailer or to be assembled to form a paper product comprising several sheets, for example, a set of printed forms or the like.

The present invention also relates to the use of these paper products as pressure-seal mailers and their use in the production of sets of printed forms, as well as to the use of the paper product in the production of laser-printable paper products with increased protection against tampering.

### BACKGROUND OF THE INVENTION

When the prior-art laser-printable paper products, which, after printing, can be sealed to form so-called pressure-seal mailers and which are known, e.g., from DE 36 28 471 A1, are printed by means of laser printers, problems increasingly arise when high-performance printers are used, which print at a very high printing speed. When using this type of laser printer, it is necessary to increase the temperature of the fixing station, at which the toner material that initially adheres only loosely to the paper is fixed to the paper surface, in accordance with the higher paper throughput or the higher rate of paper flow to ensure that the toner material is sufficiently fixed to the paper surface within the available time, which is now considerably shorter.

To prevent the toner material in the fixing station, in particular the heat roller of the fixing station, from gumming up parts of the equipment or from making sheets of paper stick to one another, it is necessary to apply a release agent to the fixing roller, which release agent in the majority of cases contains silicone oil as the main component. As the fixing temperatures increase, a higher quantity of release agent must be used.

Release agents, in particular silicone oils, however, have especially pronounced anti-adhesive effects, which means that the adhesive properties of the adhesive coating of the paper products printed with laser printers are markedly reduced or even completely destroyed or suppressed.

In this context, the patent specification EP 0,257,545 B1, e.g., describes an adhesive that is applied to the full surface of a paper substrate and subsequently printed with a laser printer, then, heat and pressure are used to produce defined adhesive joints. In addition, the patent specification also discloses that, by adding pigments or waxes, etc., it is possible to fine-tune the sealing temperature of the coating to the specific laser printer. This ensures that the coating does not gum up the fixing station. Sealing takes place by application of pressure and temperature. However, when the method described in EP 0,257,545 B1 was carried out, it was found that the use of silicone oil in the fixing station either makes sealing more difficult or prevents it completely.

This effect is, unfortunately, observed to different degrees with most of the adhesive systems for the conventional pressure-seal mailers currently used:
a) adhesive systems using remoistening adhesives;
b) adhesive systems using pressure-activated self-sealing adhesives;
c) adhesive coating using thermoplastic adhesives.

Especially sensitive to silicone oils and therefore prone to failure are systems a and b, which do not ensure that the pressure-seal mailers are securely sealed, even if the silicone content on the surface is low.

To be able to better manage these negative influences, patent specifications DE 44 32 903 C1, DE 44 32 902 C1 and DE 44 32 876 proposed to solve the problem by increasing the speed at which the silicone is absorbed by the paper. By adding substances that bind silicone oil, it was possible to counteract this problem for the most part.

However, the continuously increasing printing speeds require that the doses of silicone oil used be increased as well, which means that the absorptive capacity of the paper is very rapidly exhausted, which again leads to sealing problems during the sealing procedure.

The high temperatures during toner fixation drive the silicone oil into the paper and, e.g., into the thermoplastic material; this leads to sealing problems which, during the sealing procedure, can be compensated for by very high temperatures and pressures. The result is excessive wear and noise generation in the sealing machine.

Pressure-seal mailers are increasingly used to mail, at reduced cost to the sender, information meant to be exclusively accessible to the recipient, thus making the secure sealing of the pressure-seal mailers a matter of utmost importance. Examples include letters from insurance companies notifying insurance holders or changes in the terms of their insurance policies, adjustments of insurance premiums; mailing out pay slips; mailing out bank statements, etc.

The problem of deactivating the adhesive coatings can be reduced by temporarily storing the printed papers for a certain period of time. However, this interferes greatly with the work sequence and, furthermore, involves the risk that unauthorized third parties are able to obtain access to confidential information.

Thus, the problem to be solved is to meet the increased requirements when printing adhesive-coated paper products with laser printers in which silicone oils are used as release agents so that excellent print quality can be maintained.

Another problem to be solved by the present invention is to make available a paper product, in particular for use as a pressure-seal mailer, which, after printing the paper product with a laser printer, can be further processed to create a pressure-seal mailer, i.e., the pressure-seal mailer can be sealed, online, i.e., without requiring an intermediate temporary storage of the paper.

An additional problem to be solved is to make available laser-printable paper products, the laser print of which ensures increased protection against tampering.

### SUMMARY OF THE INVENTION

The problems listed above are surprisingly solved in that silicone oil repellency is obtainable by means of the use of a hydrophilic coating. More specifically, the present invention relates to a paper product as in Claim 1, comprising a silicon oil-repellent, activatable adhesive coating that can be printed with a laser printer, with the adhesive coating used to seal the single sheet to itself or neighboring sheets of paper products to one another, and with the silicone oil repellency being obtained with the use of a substance selected from the group of fluoroalkyl sodium sulfate(s), fluoroalkyl polyoxyethylene polymer(s), polyvinyl alcohol(s) and mixtures thereof. If fluoroalkyl sodium sulfate(s) or fluoroalkyl polyoxyethylene polymer(s) is/are used, the quantity of the material causing silicone oil repellency is preferably 0.001-3.0%, and if polyvinyl alcohol(s) is/are used, it is preferably 0.1-5.0%. The adhesive coating contains, e.g., a thermoplastic polymer material as the adhesive.

The thermoplastic polymer material preferably has the following properties:

| | |
|---|---|
| a. Minimum film-forming temperature | 10-25° C., preferably 16-20° C. |
| (MFT) | |
| b. Film-forming temperature (TG) | 20-45° C., preferably 31-33° C. |

The thermoplastic polymer material preferably comprises polyvinyl acetate, copolymers of vinyl acetate and ethylene, polyvinyl chloride and/or polyacrylate dispersions. The adhesive coating may also contain a remoistening adhesive that can be activated with water and/or a pressure-activated self-sealing adhesive. The adhesive coating can be applied to defined areas or essentially to the full surface. The components of the adhesive coating are preferably fine-tuned to one another to ensure that a rapid-phase separation takes place during the coating procedure, with the silicone oil-repellent materials remaining, or being predominantly present, on the surface of a coated substrate. The adhesive is preferably applied in a quantity of 2-15 g/m². The paper products according to the present invention can be used as pressure-seal mailers in the production of sets of printed forms as described above, or in the production of documents for which an increased protection against tampering is required. Documents for which an increased protection against tampering is required are, e.g., drivers' licenses, admission tickets, identity cards, participant identification cards, temporary identification documents, user identification cards, a document for payment and credit transactions, insurance policies, securities, documents or means of payment.

Additional embodiments and advantages follow from the dependent claims.

### BRIEF DESCRIPTION OF THE FIGURES

FIG. 1 is a schematic representation of a pressure-seal mailer.

FIG. 2 shows the basic configuration of an adhesive joint between two adhesive-coated layers.

FIG. 3 shows the anchorage of a toner particle in the surface of the paper product according to the present invention after the fixing process.

### DETAILED DESCRIPTION OF THE INVENTION

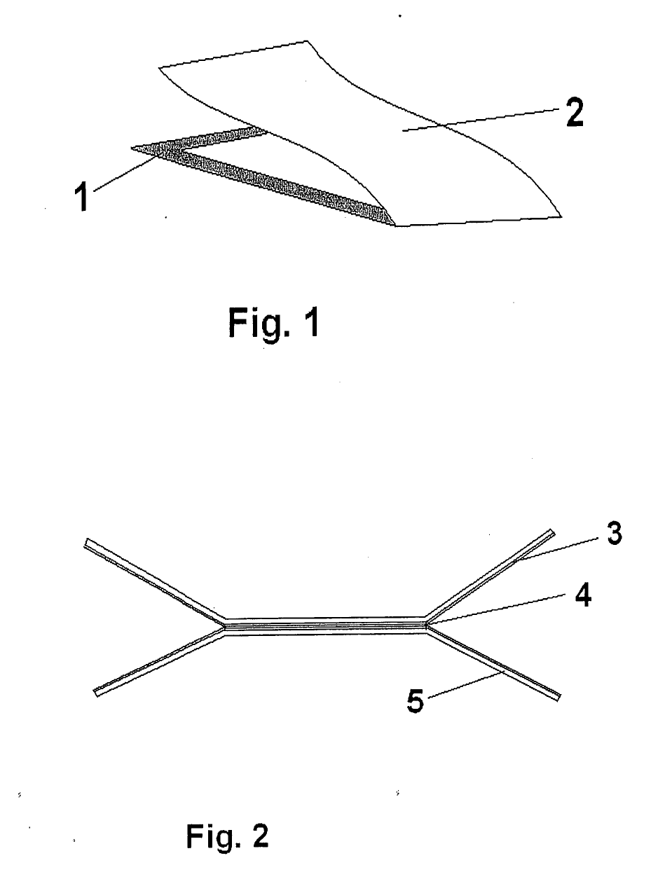

FIG. 1 is a schematic representation of a pressure-seal mailer. Reference numeral 1 designates the adhesive, which is applied to defined areas and onto which the upper part 2 of the folded pressure-seal mailer is lowered and subsequently heat-sealed by exposure to heat.

FIG. 2 shows the basic configuration of an adhesive joint 4 between two adhesive-coated areas 3 of a pressure-seal mailer or between two separate sheets, i.e., pages of paper 5, with the adhesive joint forming an integral region between the two adhesive layers that extends into the inside of the respective sheets. The thickness of the adhesive layer 3 can decrease or completely peter out. The adhesive layer 3 can also be heat-sealed to the uncoated surface of the sheets of paper 5.

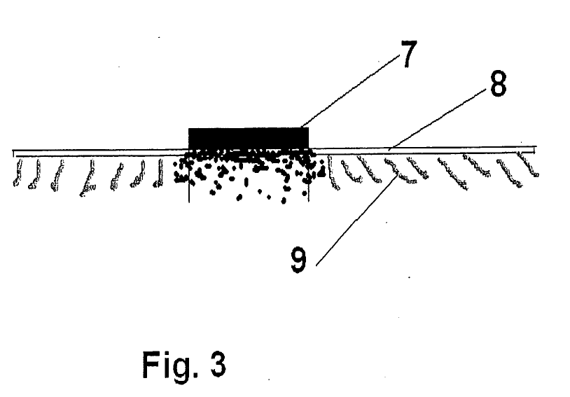

FIG. 3 shows the anchorage of a toner particle 7 in the surface of the paper product according to the present invention after the fixing process. Because of the silicone oil-repellent material used in the adhesive 8, the softened toner very clearly penetrates into the capillary network of paper 9. When silicone oil-dissolving substances, such as are proposed by the prior art, are used, the silicone oil is instead absorbed into the capillary network and, thus, prevents a deeper penetration of the toner substance into the paper body, which penetration is possible when the paper product according to the present invention is used. In the paper product according to the present invention, the degree of adhesion is higher than in the prior art.

The adhesive system preferred is an adhesive system with a thermoplastic polymer material coating as the adhesive. This adhesive coating that comprises the silicone oil-repellent substance(s) can be applied by coating the full surface of the laser printing paper and, when printing this paper with the laser printer, unexpectedly leads to a very intimate anchorage of the toner material in the paper so that the printed paper product can be considered to be of document quality. In addition, in spite of the use of the thermoplastic polymer material, the paper product according to the present invention can be readily processed in laser printers, in which the toner is fixed by means of increased temperatures, and can subsequently be sealed to form a secure adhesive bond between stacked sheets of paper by using pressure and/or temperature specifically fine-tuned to the given purpose.

A preferred thermoplastic polymer material for the adhesive is polyvinyl acetate. In principle, other thermoplastic polymer materials can be used, as well, however, optimum results with respect to the occurrence of problems with the paper during laser printing have been obtained with polyvinyl acetate, copolymers of polyvinyl acetate and polyethylene, with polyvinyl chloride and with polyacrylate dispersions. The adhesives can be used either filled, e.g., with pigments of other conventionally used auxiliary agents, or unfilled. In view of the high temperatures prevailing on the heat saddle of the laser printer, which heat saddle ensures that the toner material is fixed on the paper, the polymer materials mentioned above are particularly suitable for use as a thermoplastic polymer material.

As an alternative, it is, however, also possible to use water-activated remoistening adhesives in this invention, although such sheets of paper with this type of adhesive are sensitive to the action of moisture and, therefore, have a greater tendency to stick together when the sheets are stacked.

Another alternative obviously is an adhesive coating consisting of a pressure-activated self-sealing adhesive, however, again, this adhesive coating does not handle as easily as the adhesive coating made with a thermoplastic polymer material.

As a rule, for the production of pressure-seal mailers, one side of the paper product comprising a single sheet is coated with an adhesive, as well. It is obvious that both sides can be coated. In this case, the adhesive coating can be applied to defined areas, for example, along the edges of the paper, or, if the adhesive joints of the paper have not yet been defined, and standard sealable paper is to be produced, to the full surface. Obviously, coating the full surface is also recommended if the secondary aspect of the thermoplastic adhesive coating is to be utilized, i.e., anchoring the toner material in the paper and ensuring penetration of the toner material into the paper to ensure document-quality printing.

The hydrophilic property is obtained with the use of surfactants, in particular, fluoroalkyl sodium sulfate(s) or fluoroalkyl polyoxyethylene or polyvinyl alcohol or mixtures thereof. These substances have a silicone oil-repellent effect, on the one hand, but they also protect the polymer deep inside the coating, on the other hand.

Experiments have shown that, on exposure to heat, the use of fluoroalkyl sodium sulfate(s) or fluoroalkyl polyoxyethylene protects the thermoplastic polymer and, thus, no longer has a negative effect on the subsequent sealing procedure.

Dosing these substances also ensures that during the coating procedure, a rapid-phase separation of water from pigments and polymer takes place, which ensures that the active substances preferentially remain on the paper surface (filter effect). As a result, it is possible to reduce the temperature and the pressure in the sealing machine by 30-40%.

This leads to reduced wear and noise, saves energy and decreases the amount of coating necessary.

Due to the heat used during the fixing procedure in the laser printer, in particular in industrial high-performance laser printers, the full-surface thermoplastic coating is softened to a certain extent and, thus, promotes an intimate fusion between the toner and the paper surface. The silicone oil-repellent effect of the coating ensures that the negative influences of silicone oils on the fixing procedure are, to a large extent, precluded. If the silicone oils were absorbed, as proposed in the prior art cited, this would not be the desired case. As a result, scripts are produced that can no longer be changed by scratching or folding the document.

Thus, the present invention provides improved protection against tampering for documents, e.g., drivers' licenses, which could allow the creation of new identities, for example, by changing letters or numbers.

A few representative materials or substances that impart silicone oil repellency to the adhesive coating of the paper product according to the present invention will be described below.

### Anionic Fluorochemical Surfactants

An anionic fluorochemical surfactant can be suitably used as a hydrophilizing agent and silicone oil-repellent substance. Especially useful are fluoroalkyl sodium sulfates. Substances of this type are known by the trade name of Lodyne® and commercially available from Ciba Specialty and Huntsman. Especially useful are the products Lodyne® S-103A and S-107 B. Also known are the products 2000, 2010 and 2020 or S-152B. Chemguard®, Specialty Chemicals took over the Lodyne® series 2003. The products are now known as Chemguard®, followed by the respective number of the Lodyne® series, e.g., Chemguard® S-103A. Lodyne® or Chemguard® S-103A is an anionic fluorochemical surfactant of the fluoroalkyl sulfonate type. The melting point is 8° C., and the density is approximately 1.2 g/cm³. The flash point is 95° C. It is 100% soluble in water. The boiling point is 100° C.

### Fluoroalkyl Polyoxyethylene

Fluoroalkyl polyoxyethylene or Rf-PEG is a polyethylene glycol or polyoxyethylene with perfluorinated or partially fluorinated alkyl segments. This substance acts as a surfactant and belongs to the class of fluorochemical surfactants. A member of this surfactant class is Surflon® made by Asahi Glass. This fluorosurfactant reduces the surface tension to a degree not possible with conventional surfactants based on hydrocarbons. For example, it is effective in improving the wetting of solid surfaces, improving the leveling of fluids and stabilizing foam in all types of fluids.

Water-soluble Surflon ® products

| | | S-111n | S-113 | S-121 |
|---|---|---|---|---|
| Type | | Anionic | Anionic | Cationic |
| Appearance | | Transparent light- | Transparent light- | Transparent light- |
| | | yellow fluid | yellow fluid | yellow fluid |
| Active element (%) | | 30 | 30 | 30 |
| Solvent | | Water/isopropanol | Water/isopropanol | Water/isopropanol |
| Density (20° C.) | | 1.08 | 1.02 | 1.10 |
| pH | | 10.5 | 9.8 | 9.0 |
| Surface tension | 0.01% | 30.0 | 22.5 | 17.0 |
| (aqueous solution mn/m) | 0.1% | 17.0 | 15.8 | 16.2 |

| | S-131 | S-132 | S-141 | S-145 |
|---|---|---|---|---|
| Type | Dipolar | Dipolar | Nonionic | Nonionic |
| Appearance | Transparent | Light-yellow | Transparent | Transparent |
| | light-yellow | viscous fluid | light-yellow | light-yellow |
| | fluid | | fluid | fluid |
| Active element (%) | 30 | 30 | 30 | 30 |
| Solvent | Water/ | Water/ | Water/ | Water/ |
| | isopropanol | isopropanol | isopropanol | Isopropanol |
| Density (20° C.) | 1.08 | 1.11 | 1.10 | 1.02 |
| pH | 4.5 | 8.0 | 6.4 | 7.0 |

| | | | | | |
|---|---|---|---|---|---|
| Surface tension | 0.01% | 16.0 | 22.5 | 16.0 | 16.0 |
| (aqueous | 0.1% | 15.5 | 17.0 | 15.5 | 15.5 |
| solution mn/m) | | | | | |

Oil-soluble Surflon ® products

| | S-381 | S-383 | S-393 |
|---|---|---|---|
| Type | Nonionic | Nonionic | Nonionic |
| Appearance | Light-yellow | Light-yellow | Light-yellow |
| | viscous fluid | viscous fluid | viscous fluid |
| Active element (%) | 70 | 50 | 100 |
| Solvent | Acetic acid | Acetic acid | — |
| Density (20° C.) | 1.11 | 1.10 | 1.25 |
| Water solubility | Soluble | Soluble | Slightly |
| | | | soluble |
| | | | (<0.05%) |

| Surface tension | Water | 17.5 | — | 32.3 (0.01%) |
|---|---|---|---|---|
| (0.1%) | Acetic acid | 23.5 | 20.7 | 21.5 |
| (aqueous | Toluene | 22.5 | 21.0 | 16.3 |
| solution mn/m) | Ethyl | 25.0 | 21.6 | 18.8 |
| | Cellosolv | | | |
| | | SC-101 | KH-40 | SA-100 |
| Type | | Nonionic | Nonionic | Nonionic |
| Appearance | | Light-yellow | Reddish | Light-yellow |
| | | viscous fluid | brown solid | viscous fluid |
| Active element (%) | | 30 | 100 | 36 |
| Solvent | | Acetic acid | — | Water/ |
| | | | | ethanol/ |
| | | | | acetic acid |
| Density (20°) | | 1.01 | 1.33 (50° C.) | 0.96 |
| Water solubility | | Insoluble | Slightly | Soluble |
| | | | soluble | |
| | | | (<0.05%) | |
| Surface tension | Water | — | 23.6 (0.01%) | 22.0 |
| (0.1%) | Acetic acid | 21.0 | 23.9 | — |
| (aqueous | Toluene | 20.4 | 28.4 | — |
| solution mn/m) | Ethyl | 19.1 | 28.2 | — |
| | Cellosolv | | | |

### Polyvinyl Alcohols

In most cases, polyvinyl alcohols are produced by hydrolysis of polyvinyl acetate, in particular, after a base-catalyzed transesterification of polyvinyl acetates with alcohols (preferably methanol) in solution.

Commercially available polyvinyl alcohols have a degree of polymerization in the range of approximately 500-2500 (corresponding to molar masses of approximately 20,000-100,000 g/mol) and varying degrees of hydrolysis of 96-99, preferably 98-99 and 79-92, preferably 87-89 mol %. These commercially available polyvinyl alcohols are partially saponified polyvinyl acetates with a residual content of acetyl groups of approximately 1-4, preferably 1-2 and 8-21, especially 11-13 mol %. Manufacturers of polyvinyl alcohols identify these substances by giving the degree of polymerization of the starting polymers, the degree of hydrolysis, the saponification number and the solution viscosity. Polyvinyl alcohols are classified as toxicologically safe and are at least partially biodegradable. They are predominantly used as binders, in adhesives, sizing agents, etc.

Commercial products are available, e.g., from Rhodia, Colltec, Celanese Chemicals, Wacker-Chemie, Kuraray or Clariant. Of special interest are the products of the Mowiol® series by Clariant. The most important parameters of this product series (company brochure: Mowiol® Polyvinyl Alcohol, December 1999, Clariant GmbH Sulzbach) are summarized in the table below.

TABLE 1

| | | | | DEGREE OF | | | MAXIMUM |
|---|---|---|---|---|---|---|---|
| | | | | HYDROLYSIS | ESTER | RESIDUAL | ASH |
| | | GRADE | VISCOSITY | (saponification) | VALUE mg | ACETYL | CONTENT |
| | | NUMBER | mPa · s (1) | mol % | KOH/g (2) | CONTENT wt % | % (3) |
| PARTIALLY | Mowiol ® | 15-79 | 15 ± 2.0 | 81.5 ± 2.2 | 200 ± 20 | 15.4 ± 1.6 | 0.5 |
| HYDROLYZED | Mowiol ® | 3-83 | 3 ± 0.5 | 82.6 ± 2.2 | 190 ± 20 | 14.6 ± 1.5 | 0.5 |
| GRADES | Mowiol ® | 4-88 | 4 ± 0.5 | 87.7 ± 1.0 | 140 ± 10 | 10.8 ± 0.8 | 0.5 |
| | Mowiol ® | 5-88 | 5.5 ± 0.5 | 87.7 ± 1.0 | 140 ± 10 | 10.8 ± 0.8 | 0.5 |
| | Mowiol ® | 8-88 | 8 ± 1.0 | 87.7 ± 1.0 | 140 ± 10 | 10.8 ± 0.8 | 0.5 |
| | Mowiol ® | 18-88 | 18 ± 1.5 | 87.7 ± 1.0 | 140 ± 10 | 10.8 ± 0.8 | 0.5 |
| | Mowiol ® | 23-88 | 23 ± 1.5 | 87.7 ± 1.0 | 140 ± 10 | 10.8 ± 0.8 | 0.5 |
| | Mowiol ® | 26-88 | 26 ± 1.5 | 87.7 ± 1.0 | 140 ± 10 | 10.8 ± 0.8 | 0.5 |
| | Mowiol ® | 40-88 | 40 ± 2.0 | 87.7 ± 1.0 | 140 ± 10 | 10.8 ± 0.8 | 0.5 |
| | Mowiol ® | 47-88 | 47 ± 2.0 | 87.7 ± 1.0 | 140 ± 10 | 10.8 ± 0.8 | 0.5 |
| | Mowiol ® | 30-92 | 30 ± 2.0 | 92.4 ± 0.9 | 90 ± 10 | 6.9 ± 0.8 | 0.5 |
| FULLY | Mowiol ® | 3-96 | 3.3 ± 0.5 | 97.2 ± 0.4 | 35 ± 5 | 2.7 ± 0.4 | 1.0 |
| HYDROLYZED | Mowiol ® | 3-98 | 3.5 ± 0.5 | 98.4 ± 0.4 | 20 ± 5 | 1.5 ± 0.4 | 1.0 |
| GRADES | Mowiol ® | 4-98 | 4.5 ± 0.5 | 98.4 ± 0.4 | 20 ± 5 | 1.5 ± 0.4 | 0.5 |
| | Mowiol ® | 6-98 | 6 ± 1.0 | 98.4 ± 0.4 | 20 ± 5 | 1.5 ± 0.4 | 0.5 |
| | Mowiol ® | 10-98 | 10 ± 1.0 | 98.4 ± 0.4 | 20 ± 5 | 1.5 ± 0.4 | 0.5 |
| | Mowiol ® | 20-98 | 20 ± 1.5 | 98.4 ± 0.4 | 20 ± 5 | 1.5 ± 0.4 | 0.5 |
| | Mowiol ® | 56-98 | 56 ± 4.0 | 98.4 ± 0.4 | 20 ± 5 | 1.5 ± 0.4 | 1.0 |
| | Mowiol ® | 28-99 | 28 ± 2.0 | 99.4 ± 0.4 | 8 ± 5 | 0.6 ± 0.4 | 0.5 |

Volatile substances (DIN 53 189): maximum 5% (after 3 h of drying at 105° C.).
pH of a 4% solution in distilled water (DIN 19 260/61): 4.5-7 for partially or fully hydrolyzed grades
Bulk density (DIN 53 468): approximately 0.4-0.6 g · cm⁻³as a function of the quality.⁴⁾
(1) of a 4% aqueous solution at 20° C. (DIN 53 015)
(2) (DIN 53 401)
(3) calculated as Na₂O
⁴⁾approximate values only
Note about Table 1
The first number in the column “Grade number” denotes the viscosity at 20° C. as a relative measure for the molar mass of the Mowiol ®.
The second number denotes the degree of hydrolysis (saponification) of the polyvinyl acetate from which it is derived (partilly or fully hydrolyzed Mowiol ® grades).

The adhesive coating, i.e., the final composition that is to be applied to the substrate, is preferably mixed in two stages from the following constituents a) and b) using the prior-art method:

a)
Per 100 parts of water:
0.1 to 1.0 parts, preferably 0.2 to 0.5 parts, in particular 0.2 to 0.4 parts, of a dispersing agent.
20 to 50 parts, preferably 25 to 45 parts, in particular 30 to 40 parts, of a silica pigment.
10 to 20 parts, preferably 12.5 to 17.5 parts, in particular 14 to 16 parts, of precipitated CaCO₃.
0.1 to 20 parts, preferably 2 to 17 parts, more preferably 5 to 16 parts, in particular 7 to 15 parts, of a substance, which has been described in detail above and which is selected from the group of fluoroalkyl sodium sulfate(s), fluoroalkyl polyoxyethylene polymer(s), polyvinyl alcohol(s) and mixtures thereof.

The dispersing agent used can be a dispersing agent with or without polyphosphate. The purpose of this dispersing agent is to enhance the dispersion of the pigments. Commercially available products are products of the Dispex® series (Allied Chemicals), in particular Dispex® 100.

As a rule, the silica pigment is an amorphous calcium-modified silica pigment. Useful are products of the Shieldex® series by GRACE Davison, in particular Shieldex® AC 5.

Preferably, the pigment has an average particle size of 3-6 μm, in particular 3.8-5.2 μm, a pH value in a 10% aqueous suspension of 8.8-9.8 and a wet residue (>42 μm) of a maximum of 0.01.

Typical properties of the pigments are preferably an oil absorption value of approximately 60 g/100 g, a calcium content (relative to the dry substance) of approximately 6%, a water content of approximately 3%, and a density of approximately 1.3.

The precipitated CaCO₃ used can be a commercially available chemically precipitated calcium carbonate normally used as a filler.

b)

After mixing the constituents mentioned above, the actual adhesive, in the present case a thermoplastic polymer material, is added. The mixture thus obtained is subsequently knife-coated onto the substrate.

The thermoplastic material preferably used is a material with the following properties:

| | |
|---|---|
| a. Minimum film-forming temperature (MFT) | 10-25° C., preferably |
| | 16-20° C. |
| b. Film-forming temperature (TG) | 20-45° C., preferably |
| | 31-33° C. |

This material preferably comprises the thermoplastic polymer material polyvinyl acetate, copolymers of vinyl acetate and ethylene, polyvinyl chloride, and/or polyacrylate dispersions.

A preferred thermoplastic polymer material for the adhesive is polyvinyl acetate, in particular products of the Mowilith series (e.g., by Celanese or Clariant), in particular Mowilith DC. Mowilith DC is an aqueous vinyl acetate homopolymer dispersion without plasticizer. The solid content is 55-57% (DIN EN ISO 3252; 2 h; 105° C.). The Brookfield viscosity is approximately 1000 to 4000 mPa·s (DIN EN ISO 2555; RVT; spindle No. 3; 20 rpm, 23° C.). The pH value of the product is 4.0 to 5.0 (DIN ISO 976; undiluted). The particle size measures approximately 0.3 to 2.0 μm (DIN ISO 2115).

In addition, the adhesive composition can optionally also contain other additives conventionally used in the field, such as viscosity modifiers, corrosion inhibitors, preservatives, microbicides, etc.

In addition, it has been observed that, due to heating in the region of the heat saddle, the paper product according to the present invention is plasticized and is, therefore, able to follow sharp turns of small radii.

Lastly, it has been found that the paper product according to the present invention makes it possible, by varying the pigment fractions, to influence the blocking and sealing temperatures so that, at higher pigment fractions, a higher sealing temperature must be used, while the tendency of stacked sheets of paper toward blocking, i.e., the tendency of the paper sheets to stick to neighboring sheets or of the paper webs to stick to the rollers, is reduced by a higher blocking temperature, as well.

These and other advantages of the present invention will be explained in greater detail based on the examples below.

### EXAMPLES

### Example 1

100.0 parts of water
0.3 parts of Dispex 100 (Allied Chemicals)
35.0 parts of Shieldex AC 5 (Grace)
15.0 parts of CaCO₃, chemically precipitated
15.0 parts of Mowiol® solution 80-88 10% (Clariant)

In 100 g of water, the substances in the sequence listed above are slowly stirred into a stirring apparatus running at high speed and are homogenized for 20 min.

Subsequently, the pigment slurry is mixed with 350 parts of Mowilith DC in a stirring apparatus running at low speed.

Using a roller blade, 4.5 g/m² of the coating compound (dry weight) are applied to a 90 g/m² woodfree paper and dried at 90° C. in the drying cupboard.

The specimen is sealed using the following parameters:

| | |
|---|---|
| Time: | 2 sec |
| Pressure: | 100 N |
| Temperature: | 90° C. |

The result is an excellent and unseparable adhesive bond between the paper sheets.

Using a roller blade, the coated specimen is coated with silicone oil (XEROX FUSER AGENT Type 8R 90 163). Absorption in the paper is 3 g/m². After coating with silicone oil, the specimen is dried for 3 min at 100° C. in the drying cupboard.

After cooling the specimen, a sealing test is carried out.

Sealing parameters:

| | |
|---|---|
| Time: | 2 sec |
| Pressure: | 100 N |
| Temperature: | 90° C. |

Again, the adhesive bond between the paper specimens is excellent, while specimens prepared according to the patent specifications EP 0,257,545 A2, DE 44 32 903 C1, DE 44 32 902 C1 and DE 44 32 876 C1 can no longer be adhesive-bonded when this method is used.

### Example 2

100.0 parts of water
0.3 parts of Dispex 100 (Allied Chemicals)
35.0 parts of Shieldex AC 5 (Grace)
15.0 parts of CaCO₃, chemically precipitated
7.5 parts of Lodyne® S-103A (Ciba-Geigy), diluted with water 1:10

In 100 g of water, the substances in the sequence listed above are slowly stirred into a stirring apparatus running at high speed and are homogenized for 20 min.

Subsequently, the pigment slurry is mixed with 350 parts of Mowilith DC in a stirring apparatus running at low speed. Using a roller blade, 4.5 g/m² of the coating (dry weight) are applied to a 90 g/m² woodfree paper and dried at 90° C. in the drying cupboard.

The specimen is sealed using the following parameters:

| | |
|---|---|
| Time: | 2 sec |
| Pressure: | 100 N |
| Temperature: | 90° C. |

The result is an excellent and unseparable adhesive bond between the paper sheets.

Using a roller blade, the coated specimen is coated with silicone oil (XEROX FUSER AGENT Type 8R 90163). Absorption in the paper is 3 g/m². After coating with silicone oil, the specimen is dried for 3 min at 100° C. in the drying cupboard.

After cooling the specimen, a sealing test is carried out.

Sealing parameters;

| | |
|---|---|
| Time: | 2 sec |
| Pressure: | 100 N |
| Temperature: | 90° C. |

Again, the adhesive bond between the paper specimens is excellent, while specimens prepared according to the patent specifications EP 0,257,545 A2, DE 44 32 903 C1, DE 44 32 902 C1 and DE 44 32 876 C1 can no longer be adhesive-bonded when this method is used.

### Example 3

100.0 parts of water
0.3 parts of Dispex 100 (Allied Chemicals)
35.0 parts of Shieldex AC 5 (Grace)
15.0 parts of CaCO₃, chemically precipitated
7.5 parts of Lodyne® S-107 B (Ciba-Geigy), diluted with water 1:10

In 100 g of water, the substances in the sequence listed above are slowly stirred into a stirring apparatus running at high speed and homogenized for 20 min.

Subsequently, the pigment slurry is mixed with 350 parts of Mowilith DC in a stirring apparatus running at low speed.

Using a roller blade, 4.5 g/m² of the coating (dry weight) are applied to a 90 g/m² woodfree paper and dried at 90° C. in the drying cupboard.

The specimen is sealed using the following parameters:

| | |
|---|---|
| Time: | 2 sec |
| Pressure: | 100 N |
| Temperature: | 90° C. |

The result is an excellent and unseparable adhesive bond between the paper sheets.

Using a roller blade, the coated specimen is coated with silicone oil (XEROX FUSER AGENT Type 8R 90163). Absorption in the paper is 3 g/m². After coating with silicone oil, the specimen is dried for 3 min at 100° C. in the drying cupboard.

After cooling the specimen, a sealing test is carried out.

Sealing parameters:

| | |
|---|---|
| Time: | 2 sec |
| Pressure: | 100 N |
| Temperature: | 90° C. |

Again, the adhesive bond between the paper specimens is excellent, while specimens prepared according to the patent specifications EP 0,257,545 A2, DE 44 32 903 C1, DE 44 32 902 C1 and DE 44 32 876 C1 can no longer be adhesive-bonded when this method is used.

1. A paper product with a silicone oil-repellent, activatable adhesive coating that can be printed with a laser printer, with the adhesive coating serving to seal a single sheet to itself or neighboring sheets of paper products to one another, characterized in that the silicone oil repellency is obtained with the use of a substance selected from the group of fluoroalkyl sodium sulfate(s), fluoroalkyl polyoxyethylene polymer(s), polyvinyl alcohol(s) and mixtures thereof.

2. The paper product as in claim 1, characterized in that the amount of material required to obtain silicone oil repellency is 0.001-3.0% if fluoroalkyl sodium sulfate(s) or fluoroalkyl polyoxyethylene polymers is/are used and 0.1-5.0% if polyvinyl alcohol(s) is/are used.

3. The paper product as in claim 1 or 2, characterized in that the adhesive coating contains a thermoplastic polymer material as the adhesive.

4. The paper product as in claim 3, characterized in that the thermoplastic polymer material has the following properties:

| | |
|---|---|
| a. Minimum film-forming temperature (MFT) | 10-25° C. |
| b. Film-forming temperature (TG) | 20-45° C. |

5. The paper product as in claim 4, characterized in that the thermoplastic polymer material has the following properties:

| | |
|---|---|
| a. Minimum film-forming temperature (MFT) | 16-20° C. |
| b. Film-forming temperature (TG) | 31-33° C. |

6. The paper product as in claims 3-5, characterized in that the thermoplastic polymer material comprises polyvinyl acetate, copolymers of vinyl acetate and ethylene, polyvinyl chloride, and/or polyacrylate dispersions.

7. The paper product as in any one of the preceding claims, characterized in that the adhesive coating comprises a remoistening adhesive that can be activated with water.

8. The paper product as in any one of the preceding claims, characterized in that the adhesive coating comprises a pressure-activated self-sealing adhesive.

9. The paper product as in any one of the preceding claims, characterized in that the adhesive coating is applied to defined areas.

10. The paper product as in any one of claims 1-8, characterized in that the adhesive coating is applied to the full surface.

11. The paper product as in any one of the preceding claims, characterized in that the constituents of the adhesive coating are fine-tuned to ensure that during the coating procedure, a rapid-phase separation takes place, with the silicone oil-repellent substances essentially remaining on the surface of a coated substrate.

12. The paper product as in any one of the preceding claims, characterized in that the adhesive is applied in an amount of 2-15 g/m².

13. The paper product as in any one of the preceding claims for use as a pressure-seal mailer.

14. The use of a paper product as in any one of claims 1-12 in the production of sets of printed forms.

15. The use of a paper product as in any one of claims 1-12 in the production of documents for which an increased protection against tampering is required.

16. The use of a paper product as in claims 15, with the document being a drivers license, an admission ticket, an identity card, a participant identification card, a temporary identification document, a user identification card, a document for payment and credit transactions, an insurance policy, a security, a document or a means of payment.
